(19) United States
(12) Patent Application Publication
(10) Pub. No.: US 2026/0367550 A1
(43) Pub. Date: Nov. 19, 2026

(54) IMAGE FORMING APPARATUS

(71) Applicant: CANON KABUSHIKI KAISHA, Tokyo (JP)

(72) Inventors: TAKUYA HASEGAWA, Tokyo (JP); KENICHI TANAKA, Ibaraki (JP); RIKIYA TAKEMASA, Chiba (JP); TAKESHI KOZUMA, Ibaraki (JP); TATSUO YASUI, Tokyo (JP); MASAKI FURUTANI, Chiba (JP)

(21) Appl. No.: 19/638,236

(22) Filed: Apr. 3, 2026

(30) Foreign Application Priority Data
May 16, 2025 (JP) 2025-082533

(51) Int. Cl. G03G 15/20; G03G 21/16

(52) U.S. Cl. CPC G03G 15/2028; G03G 15/2064; G03G 21/1638; G03G 2215/00413; G03G 2215/00548; G03G 2215/2038

(57) ABSTRACT

An image forming apparatus includes a fixing device and a door provided to a casing and for permitting access to the fixing device in an opened state thereof. The fixing device includes a belt, a rotatable member forming a nip, a stretching roller disposed inside the belt and a steering roller disposed so that a rotatable axis thereof is inclinable in a predetermined direction parallel to a rotational axis direction of the stretching roller and for controlling a position of the belt in the rotational axis direction by being inclined. When the door is opened in a state of the recording material being not in the nip, an angle of the steering roller to the predetermined direction becomes a first angle, and when the door is opened in a state of being in the nip, the angle becomes a second angle larger than the first angle.

### BACKGROUND

### Field of the Technology

The present disclosure relates to an image forming apparatus such as a copier, a printer, a fax machine, and a multifunction printer which include a plurality of these functions.

### Description of the Related Art

The image forming apparatus includes a fixing device which fixes a toner image carried on a recording material onto the recording material. As the fixing device, a configuration, which is disclosed in Japanese Laid-Open Patent Application (JP-A) 2003-195671, wherein the toner image on the recording material is conveyed while it is heated in a nip portion which is formed between an endless belt member and a rotatable member, is known.

Further, in the fixing device which applies a belt member, the belt member may deviate in one direction with respect to a width direction while the belt member is rotating. Therefore, in Japanese Laid-Open Patent Application (JP-A) 2015-59964, a configuration is known, which detects a position of the belt member with respect to the width direction and controls the belt member to reciprocate (belt lateral deviation control) based on the detected result.

### SUMMARY

The present disclosure provides a configuration which is capable of suppressing a positional deviation of the belt member during a jam processing.

According to an aspect of the present invention, there is provided an image forming apparatus comprising: a casing: a fixing device disposed in the casing and configured to heat a toner image carried on a recording material and to fix the toner image onto the recording material; a door provided to the casing so as to be openable and closeable, the door being configured to permit access to the fixing device in an opened state thereof; and an opening and closing detecting portion configured to detect opening/closing of the door, wherein the fixing device includes an endless belt member, a rotatable member configured to rotate in contact with an outer peripheral surface of the belt member and to form a nip portion for nipping and conveying the recording material between the rotatable member and the belt member, a stretching roller disposed inside the belt member and configured to stretch the belt member, a steering roller disposed so that a rotatable axis thereof is inclinable with respect to a predetermined direction parallel to a rotational axis direction of the stretching roller, the steering roller being configured to control a position of the belt member with respect to the rotational axis direction of the stretching roller by being inclined, a driving portion configured to incline the steering roller, and a recording material detecting portion configured to detect presence of the recording material in the nip portion, wherein when the opening/closing detecting portion detects opening of the door in a state in which the recording material detecting portion does not detect the presence of the recording material, an angle of the steering roller to the predetermined direction becomes a first angle, and wherein when the opening/closing detecting portion detects the opening of the door in a state in which the recording material detecting portion detects the presence of the recording material, the angle of the steering roller to the predetermined direction becomes a second angle larger than the first angle.

Further features of the present disclosure will become apparent from the following description of exemplary embodiments with reference to the attached drawings.

### BRIEF DESCRIPTION OF THE DRAWINGS

FIG. 1 is a sectional view of a schematic configuration showing an image forming apparatus according to an embodiment.

FIG. 2 is a sectional view of a schematic configuration showing a fixing device according to the embodiment.

Part (a) of FIG. 3 is a sectional view of a schematic configuration of a steering roller according to the embodiment, and part (b) of FIG. 3 is a sectional view along line A-A.

Part (a) of FIG. 4 is a perspective view showing a vicinity of the steering roller according the embodiment, and part (b) of FIG. 4 is a schematic view illustrating a state in which the steering roller inclines.

FIG. 5 is a perspective view showing a configuration which detects an end surface position of the fixing belt according to the embodiment.

FIG. 6 is a sectional view of a schematic configuration of the fixing device showing a state while a recording material detecting portion according to the embodiment is not detecting a recording material.

FIG. 7 is a sectional view of a schematic configuration of the fixing device showing a state while the recording material detecting portion according to the embodiment is detecting the recording material.

FIG. 8 is a schematic view showing a state of pulling the recording material out from a nip portion.

FIG. 9 is a block diagram showing a part of a control configuration of the image forming apparatus according to the embodiment.

FIG. 10 is a flowchart of a control according to the embodiment.

Part (a) of FIG. 11 is a perspective view showing the steering roller in a state parallel to a heating roller, and part (b) of FIG. 11 is a perspective view showing the steering roller in a state inclined with respect to the heating roller

Part (a) of FIG. 12 is a schematic view showing a relationship between the fixing belt and the steering roller while the steering roller is in a neutral position, and part (b) of FIG. 12 is a sectional view along line B-B.

Part (a) of FIG. 13 is schematic view showing a relationship between the fixing belt and steering roller while the steering roller is inclined, and part (b) of FIG. 13 is a sectional view along C-C.

### DESCRIPTION OF THE EMBODIMENTS

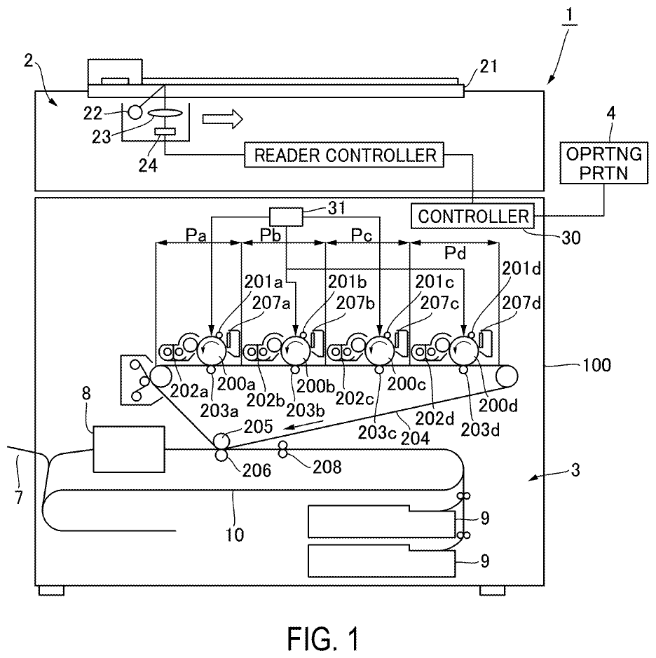

In the following an embodiment of the present invention will be described with reference to Figures from 1 through 13. First of all, a schematic configuration of the image forming apparatus according to the embodiment will be described with reference to FIG. 1.

### Image Forming Apparatus

An image forming apparatus 1 includes four image forming portions Pa, Pb, Pc, and Pd which are provided corresponding to four colors of yellow, magenta, cyan, and black, and it is a full color electrophotographic type printer. In the embodiment, it is a tandem type in which the image forming portions Pa, Pb, Pc, and Pd are disposed along a rotational direction of an intermediary transfer belt 204 which will be described below. The image forming apparatus 1 forms a toner image (an image) on a recording material in accordance with an image signal from an image reading portion (document reading apparatus) 2 which is connected to an image forming apparatus main assembly 3 or from a host device such as a personal computer which is communicably connected to the image forming apparatus main assembly 3. The recording material may be a sheet material such as paper, plastic film, or cloth.

The image forming apparatus 1 comprises the image reading portion 2 and the image forming apparatus main assembly 3. The image reading portion 2 reads a document which is placed on a document glass 21, wherein light, which is irradiated from a light source 22, is reflected by the document and focused on a CCD sensor 24 via an optical system member 23 such as a lens. Such an optical unit converts the document into a sequence of electrical signal data of each line by scanning in a direction which is indicated by an arrow. The image signal which is obtained by the CCD sensor 24 is sent to the image forming apparatus main assembly 3, where image processing which corresponds to each image forming portion which will be described below is performed by a control portion 30. Further, the control portion 30 also receives an external input as an image signal from an external host device such as a print server.

The image forming apparatus main assembly 3 comprises the plurality of image forming portions Pa, Pb, Pc, and Pd, and image forming is performed in each of the image forming portions based on the image signal which is described above. That is, the image signal is converted into a laser beam which is subjected to PWM (Pulse Width Modulation) by the control portion 30. A polygon scanner 31 as an exposure device scans a laser beam in accordance with the image signal. And the laser beam is irradiated onto photosensitive drums from 200a through 200d as image bearing members of the image forming portions from Pa through Pd, respectively.

Incidentally, Pa is a yellow (Y) image forming portion, Pb is a magenta (M) image forming portion, Pc is a cyan (C) image forming portion, and Pd is a black (Bk) image forming portion, and each of the image forming portions forms an image of the corresponding color. Since the image forming portions from Pa through Pd are substantially identical, the Y image forming portion Pa will be specifically described below and descriptions of the other image forming portions will be omitted. In the image forming portion Pa, a toner image is formed on the surface of the photosensitive drum 200a based on the image signal, as described below.

A charging roller 201a as a primary charger charges a surface of the photosensitive drum 200a to a predetermined potential, and performs preparation for electrostatic latent image formation. A laser beam from the polygon scanner 31 forms an electrostatic latent image on the surface of the photosensitive drum 200a, which has been charged to the predetermined potential. The developing device 202a develops the electrostatic latent image on the photosensitive drum 200a and forms a toner image. The primary transfer roller 203a discharges from a back surface of the intermediary transfer belt 204 and applies a primary transfer bias of opposite polarity to the toner, and transfers the toner image on the photosensitive drum 200a onto the intermediary transfer belt 204. After transferring, a cleaner 207a cleans the surface of the photosensitive drum 200a.

Further, the toner image on the intermediary transfer belt 204 is conveyed to a subsequent image forming portion, the toner image of each color which is formed in each of the image forming portions is transferred in an order of Y, M, C, and Bk, and a four color image is formed on its surface. And the toner image, which has passed through the Bk image forming portion Pd, which is positioned at the most downstream side in the rotational direction of the intermediary transfer belt 204, is conveyed to a secondary transfer portion which is configured of a secondary transfer roller pair 205, 206. And, in the secondary transfer portion, when a secondary transfer electric field of opposite polarity to the toner image on the intermediary transfer belt 204 is applied, the toner image is secondarily transferred to the recording material.

The recording material is accommodated in a cassette 9, and the recording material which is fed from the cassette 9 is conveyed to a registration portion 208, which is configured of a pair of registration rollers, for example, and waits at the registration portion 208. After that, a timing of the registration portion 208 is controlled so as to align a paper with the toner image on the intermediary transfer belt 204 and the registration portion 208 conveys the recording material to the secondary transfer portion.

The recording material onto which the toner image has been transferred at the secondary transfer portion is conveyed to the fixing device 8, and the toner image which is carried on the recording material is fixed to the recording material when heat and pressure are applied in the fixing device 8. The recording material which has passed through the fixing device 8 is discharged to the discharge tray 7. Incidentally, in a case of image forming on both sides of the recording material, after transferring and fixing of the toner image onto a first surface (front surface) of the recording material are completed, the recording material is conveyed through a reversing conveyance portion 10 to reverse the front and back of the recording material, transferring and fixing of the toner image onto a second surface (back surface) of the recording material are performed, and the recording material is stacked on the discharge tray 7.

Incidentally, the control portion 30 controls the entire image forming apparatus 1 as described above. Further, the control portion 30 is capable of various settings, etc. based on an input from an operation portion 4 in which the image forming apparatus 1 includes. The control portion 30 includes a CPU (Central Processing Unit), a ROM (Read Only Memory), and RAM (Random Access Memory). The CPU controls each portion while reading a program which corresponds to a control procedure which is stored in the ROM. Further, the RAM stores working data and input data, and the CPU performs control with reference to the data which are stored in the RAM based on the program which is described above, etc.

### Fixing Device

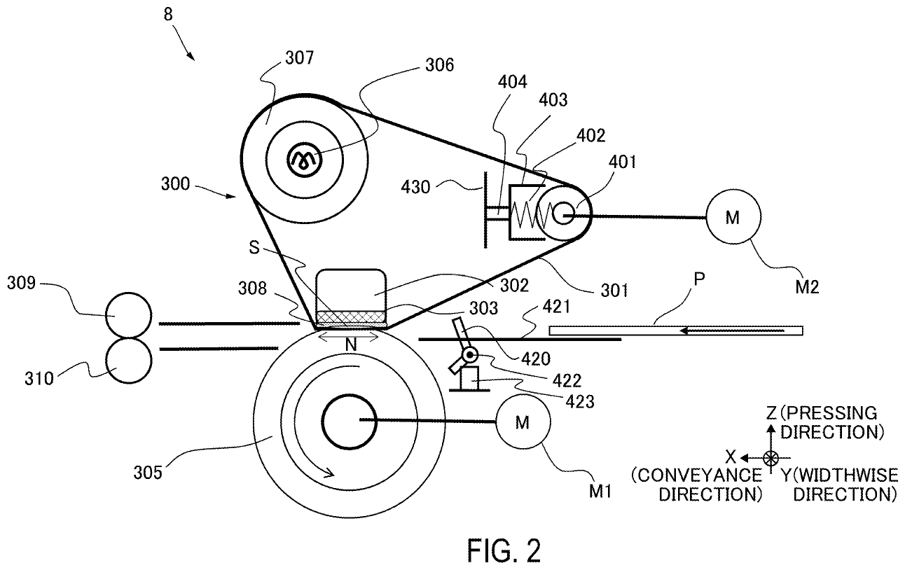

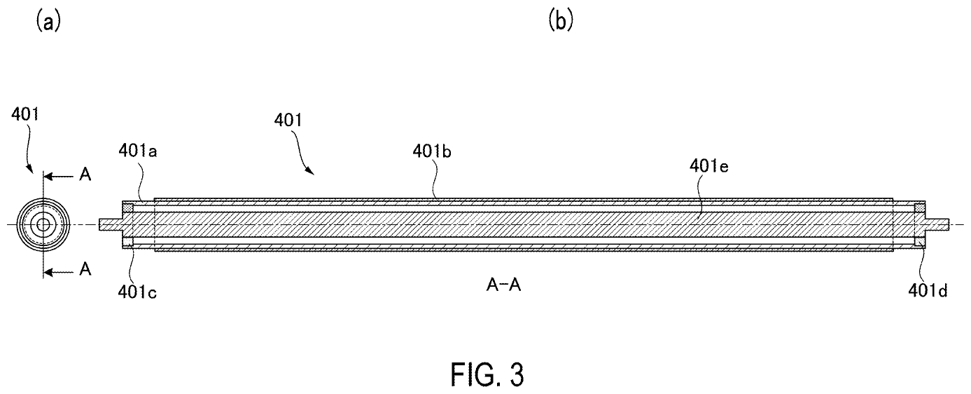

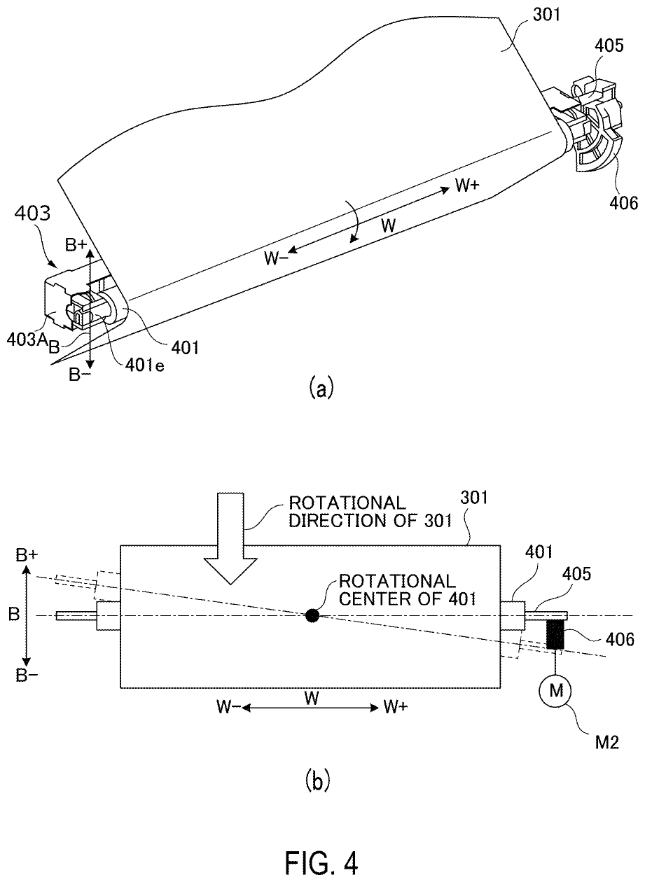

Next, a configuration of the fixing device 8 according to the embodiment will be described with reference to FIG. 2. FIG. 2 is a sectional view showing a schematic configuration of the fixing device 8. In the embodiment, the fixing device of a belt heating type which uses an endless belt member is applied. In FIG. 2, an X direction indicates a direction in which the recording material P is conveyed, a Y direction indicates a width direction intersecting (perpendicular to, in the embodiment) the direction in which the recording material P is conveyed, and a Z direction indicates a pressing direction of the pressing roller 305 which will be described below. These directions are perpendicular to each other. Further, one side in the width direction (Y direction) is a front side of the image forming apparatus 1, which is a side that the operation portion 4 is disposed and operated by a user. On the other hand, an opposite side in the width direction is a rear side of the image forming apparatus 1.

The fixing device 8 includes a heating unit 300 which includes a fixing belt 301 as an endless and rotatable belt member, and a pressing roller 305 as a rotatable member which contacts the fixing belt 301 and forms a nip portion N with the fixing belt 301.

The heating unit 300 includes the fixing belt 301 which is described above, a fixing pad 303 as a pad member, a steering roller 401, and a heating roller 307 as a stretching roller. The pressing roller 305 rotates while contacting an outer peripheral surface of the fixing belt 301 and is also a rotatable driving member which applies a driving force to the fixing belt 301.

The fixing belt 301 as a fixing member and a rotatable member is thermally conductive and heat resistant, and is formed in a thin walled cylindrical shape. In the embodiment, it is a three layer structure in which a base layer, an elastic layer on an outer periphery of the base layer, and a release layer on an outer periphery of the elastic layer are formed. And the base layer is 80 μm thick and made of polyimide resin (PI), the elastic layer is 300 μm thick and made of silicone rubber, and the release layer is 30 μm thick and made of PFA (tetrafluoroethylene perfluoroalkoxy vinyl ether copolymer) as a fluorocarbon resin. This fixing belt 301 is stretched by the fixing pad 303, the heating roller 307, and the steering roller 401.

The fixing pad 303 is non-rotatably disposed on an inside of the fixing belt 301, so as to oppose the pressing roller 305 while nipped with the fixing belt 301. The fixing pad 303 forms a nip portion N which nips and conveys the recording material between the fixing belt 301 and the pressing roller 305. In the embodiment, the fixing pad 303 is a substantially plate shaped member which is long in a width direction of the fixing belt 301 (a longitudinal direction which intersects a rotational direction of the fixing belt 301, a rotational axis direction of the heating roller 307). The nip portion N is formed as the fixing pad 303 is pressed against the pressing roller 305 while nipping the fixing belt 301. The fixing pad 303 is made of LCP (liquid crystal polymer) resin.

A lubricating sheet 308, whose surface is coated with PTFE (polytetrafluoroethylene), and silicone oil S (hereinafter, referred to as oil S) as a lubricant are interposed between the fixing pad 303 and the fixing belt 301, and the fixing belt 301 is able to slide smoothly against the fixing pad 303. The lubricating sheet 308 is formed by coating PTFE onto a surface of a 70μm thick polyimide substrate. Incidentally, since the lubricating sheet 308 is disposed in order to improve sliding properties between the fixing pad 303 and the fixing belt 301, it is possible to substitute the lubricating sheet 308 by applying a coating, etc. to a surface layer of the fixing pad 303 to enhance the sliding properties.

The fixing pad 303 is supported by a stay 302 as a support member which is disposed inside the fixing belt 301. That is, the stay 302 is disposed in an opposite side of the pressing roller 305 with respect to the fixing pad 303 and supports the fixing pad 303. The stay 302 is a rigid reinforcement member which is long along a longitudinal direction of the fixing belt 301, and it contacts the fixing pad 303 and backs up the fixing pad. That is, when the fixing pad 303 is pressed by the pressing roller 305, the stay 302 provides sufficient strength to the fixing pad 303 to secure a pressing force at the nip portion N.

The heating roller 307 is disposed inside the fixing belt 301, and stretches the fixing belt 301 together with the fixing pad 303 and the steering roller 401. The heating roller 307 is formed in a cylindrical shape from a metal such as aluminum or stainless steel, and a halogen heater 306 is arranged inside it as a heating portion for heating the fixing belt 301. And the heating roller 307 is heated to a predetermined temperature by the halogen heater 306.

In the embodiment, the heating roller 307 is formed, for example, of a stainless steel pipe with a thickness of 1 mm. Further, one halogen heaters 306 may be provided, or a plurality of halogen heaters may be provided. Incidentally, the heating portion is not limited to a halogen heater, however, it may be any heater which is capable of heating the heating roller 307 such as a carbon heater, for example. The fixing belt 301 is heated by the heating roller 307 which is heated by the halogen heater 306, and is controlled to a predetermined target temperature in accordance with a type of recording material based on temperature detection by a thermistor which is not shown.

The steering roller 401 is disposed in an inner side of the fixing belt 301, stretches the fixing belt 301 together with the fixing pad 303 and the heating roller 307, and rotationally driven by the fixing belt 301. Further, in a case of the embodiment, the steering roller 401 is urged by an urging spring 402 as an urging member which is supported by a frame 430 of the heating unit 300, and is also a tension roller which applies a predetermined tension to the fixing belt 301.

The steering roller 401 is configured of a cylindrical member 401a and an elastic layer 401b which is disposed around the cylindrical member 401a, as shown in part (a) and part (b) of FIG. 3. Part (a) of FIG. 3 is a sectional view of the steering roller 401 when it is cut perpendicular to its rotational axis, and part (b) of FIG. 3 is a sectional view of the steering roller 401 when it is cut along its rotational axis. For example, the cylindrical member 401a is a stainless steel pipe with an outer diameter of 20 mm and a thickness of 1 mm, and, further, the elastic layer 401 b is configured of a silicone rubber layer with a thickness of 100 μm.

Further, as shown in part (b) of FIG. 3, both end portions of the steering roller 401 with respect to the longitudinal direction (rotational axis direction) are rotatably supported by a bearing 401c and a bearing 401d, respectively. That is, the bearing 401c and the bearing 401d are disposed at both end portions of a rotational support shaft 401e with respect to the longitudinal direction, and the cylindrical member 401a is rotatably supported by the rotational support shaft 401e via the bearing 401c and the bearing 401d at both end portions. Therefore, the steering roller 401 is rotationally driven with respect to the fixing belt 301, while being supported by the rotational support shaft 401e via the bearing 401c and the bearing 401d.

The pressing roller 305 rotates while contacting the outer peripheral surface of the fixing belt 301, and applies the driving force to the fixing belt 301. In the embodiment, the pressing roller 305 is a roller in which an elastic layer on an outer periphery of its shaft and a release layer on an outer periphery of the elastic layer are formed. Further, the shaft is made of stainless steel with a diameter of 72 mm, the elastic layer is made of conductive silicone rubber with a thickness of 8 mm, and the release layer is made of PFA (tetrafluoroethylene perfluoroalkoxy vinyl ether copolymer) as a fluorocarbon resin with a thickness of 100 μm. The pressing roller 305 is rotatably supported by a fixing frame (not shown) of the fixing device 8, a gear is fixed to an end portion of the pressing roller 305, the pressing roller 305 is connected via the gear to a motor M1 as a pressing roller driving source, and the pressing roller 305 is rotationally driven.

In the fixing device 8 which is configured as described above, the toner image is heated at the nip portion N which is formed between the fixing belt 301 and the pressing roller 305 while nipping and conveying the recording material P which carries the toner image. And the toner image is fixed onto the recording material P. Therefore, it is necessary for the fixing device 8 to perform both a function of applying heat and pressure and a function of conveying the recording material P. The pressing roller 305 is pressed against the fixing pad 303 via the fixing belt 301 by a driving source which is not shown. In the embodiment, pressing force at the nip portion N (NF) during image forming is 1600N, its length in the X direction (the conveying direction) is set to 24.5 mm and its length in the Y direction (width direction) is set to 326 mm. Further, in a downstream of the nip portion N with respect to the conveying direction of the recording material P, a discharging roller pair 309 and 310 is disposed to discharge the recording material P which has passed through the nip portion N to an outside of the fixing device 8.

### Steering Portion

The steering roller 401, in the fixing device 8 according to the embodiment, is disposed so that the its rotational axis is inclinable with respect to a predetermined direction which is parallel to the rotational axis direction (width direction, longitudinal direction) of the heating roller 307. And when the steering roller 401 is inclined, a position (lateral deviation position) of the fixing belt 301 with respect to the rotational axis direction of the heating roller 307 is controlled. That is, the steering roller 401 includes a rotational center at a center or an end portion with respect to the rotational axis direction (longitudinal direction) of the steering roller 401, and inclines with respect to the longitudinal direction of the heating roller 307 by swinging around the rotational center. Accordingly, by generating a tension difference between one side and the other side of the fixing belt 301 with respect to the longitudinal direction, the fixing belt 301 is moved in the longitudinal direction.

The fixing belt 301 may deviate toward one end portion during rotation due to factors such as outer diameter accuracies of the rollers which are stretched and alignment accuracies between each roller. Therefore, the lateral deviation is controlled by the steering roller 401 which also functions as a steering roller. Incidentally, the steering roller 401 may be swung by a driving source such as a motor, or may be configured so as to swing by automatic alignment.

The steering roller 401 according to the embodiment will be more specifically described below. As shown in FIG. 2, the steering roller 401 is supported by the steering portion 403, while stretching the fixing belt 301. The steering portion 403 is supported such that the steering roller 401 is able to vary its contact angle with the fixing belt 301 by rotating about the rotational shaft 404 as a fulcrum with respect to the frame 430 of the heating unit 300.

Further, both end portions of the steering roller 401 are urged against the fixing belt 301 with a force of 50N on each side by the urging spring 402 which is supported by the steering portion 403, thereby also serving as a tension roller to apply a predetermined tension force to the fixing belt 301. That is, the steering roller 401 according to the embodiment functions as both a steering roller and a tension roller.

### Steering Operation

A steering operation of the steering roller 401 will be described with reference to part (a) and part (b) of FIG. 4. Part (a) of FIG. 4 is a perspective view of a vicinity of the steering roller 401 when the fixing belt 301 is stretched, and part (b) of FIG. 4 is a schematic diagram showing a state that the steering roller 401 is inclined together with the fixing belt 301.

The steering roller 401 is rotatably supported with respect to the frame 430 of heating unit 300 via the steering portion 403 as described above. The steering portion 403 includes a steering main body portion 403A which supports the steering roller 401 via the rotational support shaft 401e, a steering shaft 405 which is provided at an end portion of the steering main body portion 403A, and a steering arm 406. The steering arm 406 is driven by a motor M2 as a driving portion which inclines the steering roller 401, and swings the steering shaft 405 in a direction of an arrow B which is shown in part (a) and part (b) of FIG. 4. Accordingly, the steering main body portion 403A rotates about the rotational shaft 404 (FIG. 2) via the steering shaft 405, so that the steering roller 401 is capable of changing its angle with respect to the fixing belt 301.

In this way, as the angle of the steering roller 401 changes, the fixing belt 301 which is stretched over it moves along a width direction (longitudinal direction) W. In a case that the steering roller 401 inclines in a direction of an arrow B+ which is shown in part (a) and part (b) of FIG. 4, the fixing belt 301 is moved in a direction of an arrow W− which is shown in part (a) and part (b) of FIG. 4 (belt front lateral deviation control), which is on a front side of the fixing device 8. On the other hand, in a case that the steering roller 401 inclines in a direction of an arrow B− in part (a) and part (b) of FIG. 4, the fixing belt 301 is moved in a direction of an arrow W+ in part (a) and part (b) of FIG. 4 (belt rear lateral deviation control), which is on a rear side of the fixing device 8. By repeating this operation, the fixing belt 301 reciprocates within a predetermined region in the width direction W. A position of the fixing belt 301 in the width direction W, that is, the lateral deviation position, is detected by a lateral deviation position detecting portion 410A, which will be described below.

### Lateral Deviation Position Detection of the Fixing Belt

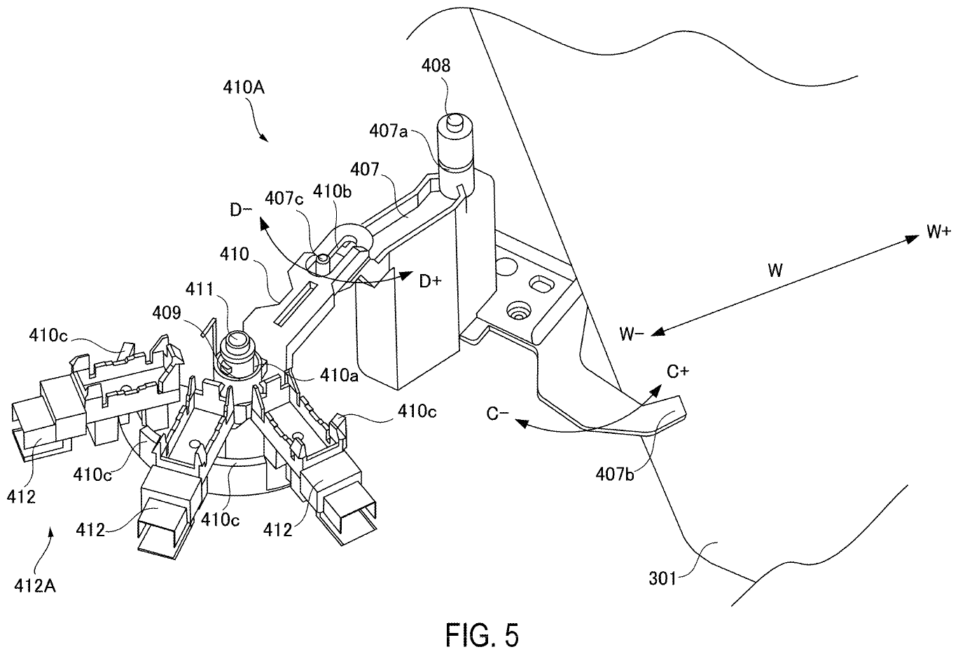

Next, the lateral deviation position detecting portion 410A will be described with reference to FIG. 5. The lateral deviation position detecting portion 410A includes a belt position detecting arm 407, a belt position detecting flag 410, a urging portion 409, and a sensor portion 412A. The belt position detecting arm 407 is rotatably held while a rotational center hole 407a is fitted to a rotational shaft 408, and is provided with the belt position detecting flag 410 as a flag member which swings in interlocking with the belt position detecting arm 407. The belt position detecting flag 410 is urged to rotate in a direction of an arrow D+which is shown in FIG. 5 by the urging portion 409 which is provided on a rotational axis of the belt position detecting flag 410. As a result, the belt position detecting arm 407 is urged to rotate in a direction of an arrow C+ which is shown in FIG. 5. A detecting portion 407b which is provided with the belt position detecting arm 407 contacts an end surface of the fixing belt 301 with a light pressure which does not hinder movement of the fixing belt 301 in the width direction W due to the urging force. In the embodiment, this pressure is set to approximately 1 gf.

The belt position detecting flag 410 includes a rotational center hole 410a and is rotatably held while it is fitted to a rotational shaft 411. Further, the belt position detecting flag 410 swings in interlocking with the belt position detecting arm 407 via an elongated hole 410b which is formed therein and a shaft 407c which is formed in the belt position detecting arm 407.

A sensor portion 412A includes a plurality of optical sensors 412. The belt position detecting flag 410 includes a light shielding portion 410c, and the plurality of optical sensors 412 are provided in the vicinity of the light shielding portion 410c. When a posture angle of the belt position detecting flag 410 changes and the light shielding portion 410c moves, on/off states of signals which are returned by the respective optical sensors 412 also changes, so that a position of the fixing belt 301 can be detected based on a combination of the signals. The lateral deviation control of the fixing belt 301 is performed by combining a control of the motor M2 of the steering arm 406 which is described above with the lateral deviation position detecting portion 410A using the belt position detecting flag 410.

### Detection of the Recording Material Which is Remained in the Nip Portion

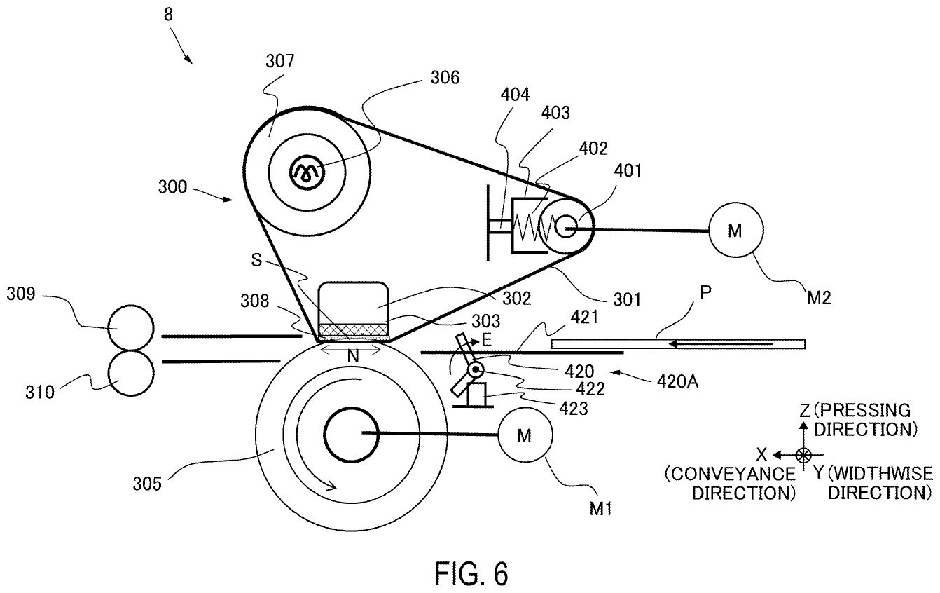

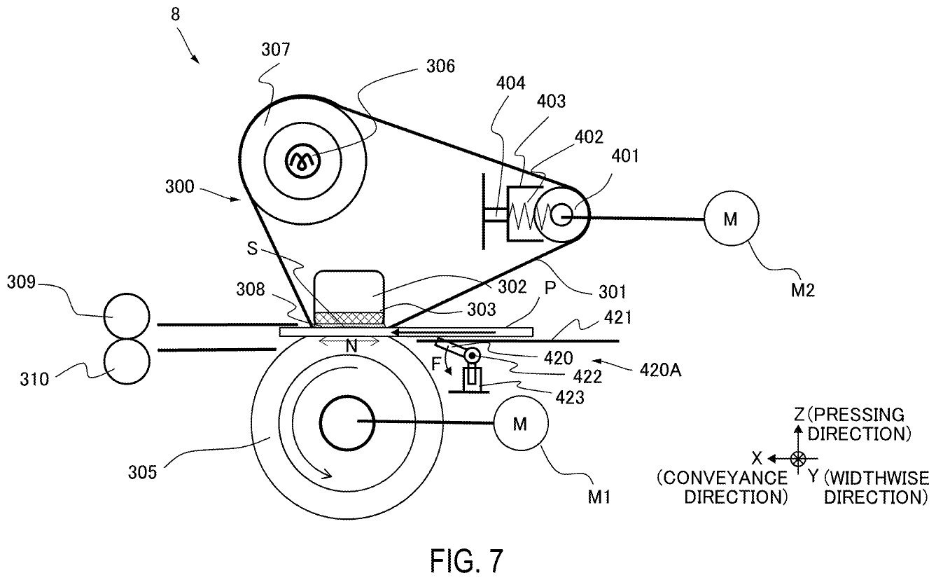

Next, a configuration of a recording material detecting portion 420A, which detects presence of the recording material in the nip portion N of the fixing device 8, will be described with reference to FIG. 6 and FIG. 7. The recording material detecting portion 420A includes a detecting flag 420 and a detecting sensor 423. As shown in FIG. 6 and FIG. 7, the detecting flag 420 is disposed on an upstream side of the nip portion N with respect to the conveying direction of the recording material P.

As shown in FIG. 6, the detecting flag 420 is rotatably held by a rotational shaft 422, and is disposed to block a conveyance passage 421 of the recording material when it is urged in a direction of an arrow E by an elastic member (not shown). Further, the detecting sensor 423 is disposed in a vicinity of the detecting flag 420. The detecting sensor 423 includes a light emitting portion which emits light and a light receiving portion which receives light. The detecting sensor 423 outputs an ON signal when the detecting flag 420 enters between the light emitting portion and the light receiving portion, and outputs an OFF signal when the detecting flag 420 retracts from between the light emitting portion and the light receiving portion so that the light is received by the light receiving portion.

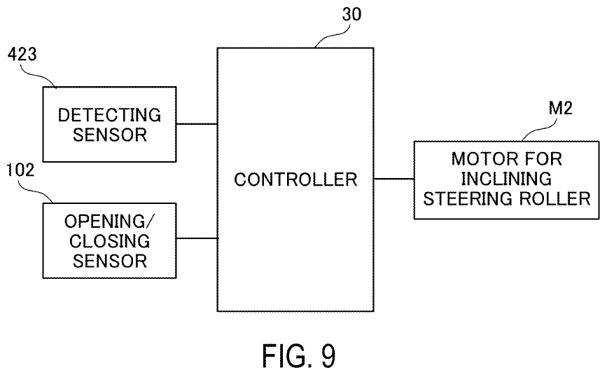

As shown in FIG. 7, when the recording material P is conveyed to the nip portion N via the conveyance passage 421, the detecting flag 420 is pushed down by the recording material P in a direction of an arrow F. Since a force which urges the detecting flag 420 in the direction of the arrow E is set to be less than a force which is pushed down by the recording material P, the detecting flag 420 rotates in the direction of the arrow F by the force which is pushed down by the recording material P. And when the rotated detecting flag 420 enters between the light emitting portion and the light receiving portion of the detecting sensor 423, the detecting sensor 423 outputs the ON signal. Here, in a case that the recording material P is remained in the nip portion N such that the recording material P which has entered the nip portion N winds around the fixing belt 301, the detecting flag 420 remains in a state which is shown in FIG. 7 and the detecting sensor 423 outputs the ON signal. The signal of the detecting sensor 423 is sent to the control portion 30 (see FIG. 1 and FIG. 9 which will be described below), and the control portion 30 detects that the recording material P remains in the nip portion N, that is, a jam is occurred.

### Jam Processing

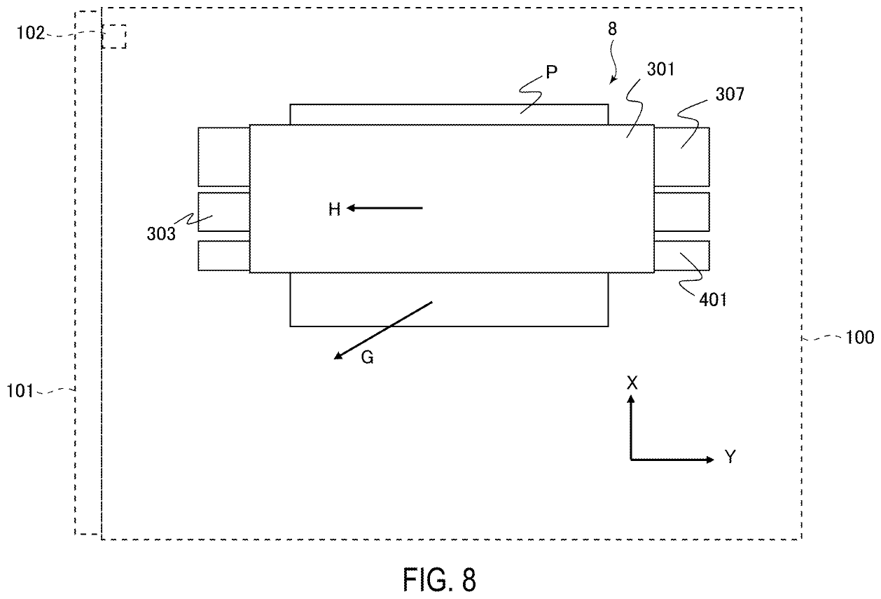

Next, jam processing, in a case that jam of the recording material is occurred as described above, will be described with reference to FIG. 8. FIG. 8 is a schematic diagram showing the fixing device 8 which is disposed inside a casing 100 of the image forming apparatus main assembly 3. As shown in FIG. 1, inside the casing 100, the image forming portions Pa, Pb, Pc, and Pd, and a conveying passage for the recording material, etc. are disposed in addition to the fixing device 8. For example, a door 101, which is configured to be openable and closable with respect to the casing, is provided in a front side (one side in the width direction (Y direction)) of the image forming apparatus 1. The fixing device 8 is accessible, while the door 101 is opened. Further, the casing 100 is provided with an opening/closing sensor 102 as an opening/closing detecting portion which detects opening/closing of the door 101. The control portion 30 detects that the door 101 has opened based on a signal from the opening/closing sensor 102.

When the jam of the recording material P occurs in the nip portion N of the fixing device 8, the user opens the door 101. And by pulling the recording material P out in a direction of an arrow G which is shown in FIG. 8, for example, the recording material P is removed from the nip portion N. In this case, the fixing belt 301 and the recording material P may adhere to each other, when toner is interposed between the fixing belt 301 and the recording material P which is remained. When the recording material P is pulled out from the nip portion N in this state, a force in a direction of pulling out the recording material P is generated on the fixing belt 301. In particular, when the direction of pulling out the recording material during removing the recording material approaches a direction which is perpendicular to the direction in which the recording material is conveyed (that is, width direction), a force which is generated in the longitudinal direction of the fixing belt 301 (direction H in FIG. 8, width direction) increases.

Further, as the image forming apparatus 1 has been downsized in recent years, downsizing of the fixing device 8 has been required, and accordingly a roller member which suspends the fixing belt 301 is also downsized. As the roller member becomes downsized, a contact area between the roller member and the fixing belt 301 decreases and a resistance force against the force, which is generated when removing the recording material which is remained in the nip portion N as described above, decreases. Therefore, due to downsizing of the roller member, the force which is generated in the longitudinal direction of the fixing belt 301 during removing the recording material which is remained may exceed the resistance force between the roller member and the fixing belt 301. In this way, when attempting to pull out the recording material during removing the recording material, the force which moves in the width direction may be applied to the fixing belt 301 and the position of the fixing belt 301 may deviate in the width direction.

On the other hand, in the fixing device in which the fixing belt is applied, a belt unit which is disposed inside the fixing device or parts inside the belt unit may be replaced. At this time, in order to allow the belt unit to be easily inserted into and removed from the fixing device, when the door of the image forming apparatus is opened, the steering roller may be moved to a position in a direction substantially parallel to the width direction by the belt lateral deviation control. In such a configuration in which the steering roller is provided substantially parallel to the width direction to facilitate replacement of the belt unit, etc., the resistance force between the roller member and the fixing belt 301 which is described above becomes smaller, and a positional deviation of the fixing belt 301 may become significant when the recording material is removed. Due to the positional deviation of the fixing belt 301, an error may be caused when the fixing belt 301 is positioned outside a range of lateral deviation control in the width direction (fully deviated position), and a damage to the fixing belt 301 by contacting with the other part may be caused. Therefore, in the embodiment, when the recording material is jammed in the nip portion N of the fixing device 8 and is removed, a following operation will be performed.

### Control During Door Opening Operation

As described above, when the recording material is jammed in the nip portion N of the fixing device 8 and the recording material is removed, the door 101 is opened, however, in the embodiment, as shown in FIG. 9, the control portion 30 controls the motor M2 based on the signal of the opening/closing sensor 102 and the signal of the detecting sensor 423 which is included in the recording material detecting portion 420A. That is, in a case that the control portion 30 detects that the door 101 is opened via the opening/closing sensor 102 while the recording material detecting portion 420A does not detect the recording material, it controls the motor M2 so that an angle of the steering roller 401 with respect to a predetermined direction becomes a first angle. On the other hand, in a case that the control portion 30 detects that the door 101 is opened via the opening/closing sensor 102 while the recording material detecting portion 420A detects the recording material, it controls the motor M2 so that the angle of the steering roller 401 with respect to the predetermined direction becomes a second angle which is larger than the first angle.

As described above, the motor M2 is the motor which inclines the steering roller 401, and as shown in part (a) and part (b) of FIG. 4, the steering roller 401 is inclined when the motor M2 drives the steering arm 406. The predetermined direction is parallel to the rotational axis direction of the heating roller 307 and substantially parallel to the width direction of the fixing belt 301.

In a case that the recording material detecting portion 420A does not detect the recording material when the door 101 is opened, since it is possible to determine that the door 101 is opened while the jam is not occurred in the nip portion N, the control portion 30 sets the angle of the steering roller 401 to the first angle. In the case of the embodiment, the first angle is the angle at which the rotational axis of the steering roller 401 is substantially parallel to the predetermined direction (neutral position). Therefore, in the case that the steering roller 401 is at the first angle, it becomes easier to replace the parts such as the fixing belt 301 which are configured of the heating unit 300. The first angle is not limited to a direction which is parallel to the predetermined direction, however, it may slightly inclined with respect to the predetermined direction.

In the case that the recording material detecting portion 420A detects the recording material when the door 101 is opened, since it is possible to determine that the door 101 is opened while the jam is occurred in the nip portion N, the control portion 30 sets the angle of the steering roller 401 to the second angle. In the case of the embodiment, the second angle is an angle of which the steering roller 401 to the predetermined direction becomes maximum within a rage where the steering roller 401 is capable of inclining. Therefore, in the case the steering roller 401 is at the second angle, as will be described below, the fixing belt 301 is less likely to deviate in the width direction even when the recording material is pulled out from the nip portion N. The second angle does not have to be an angle at which the angle to the predetermined direction is maximum, and may be any angle larger that the first angle.

### Operation of the Steering Portion During Opening Operation of Door

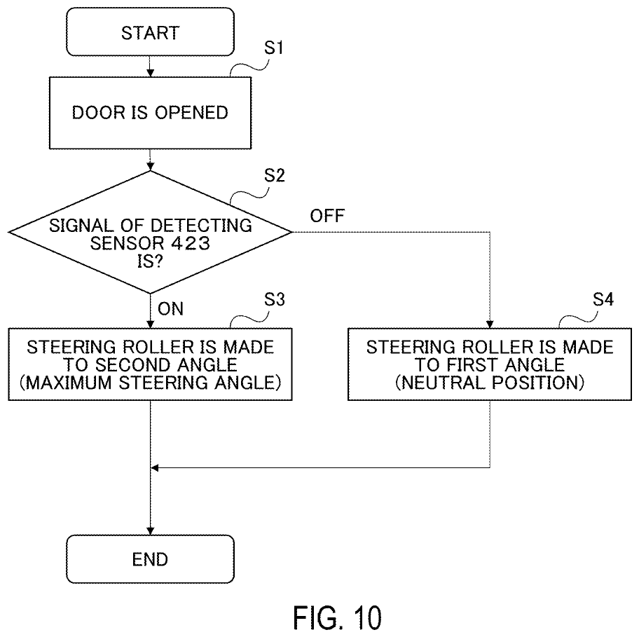

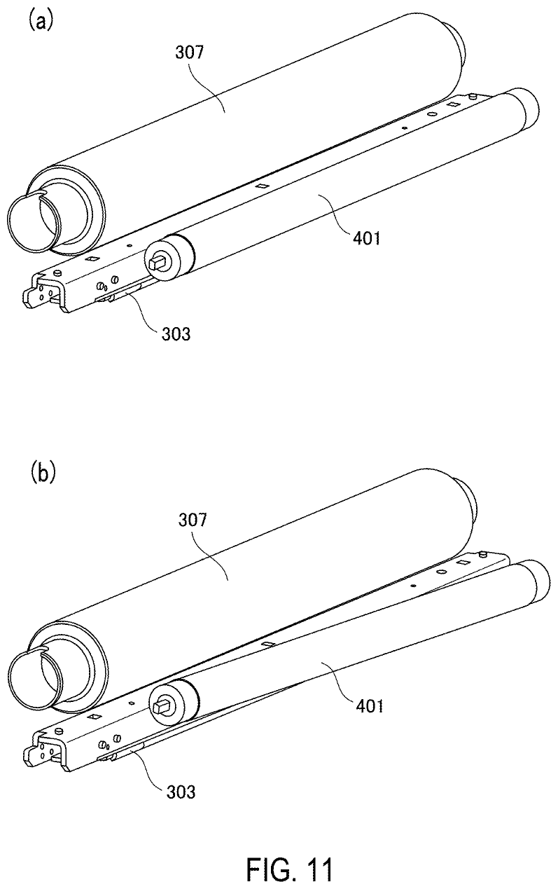

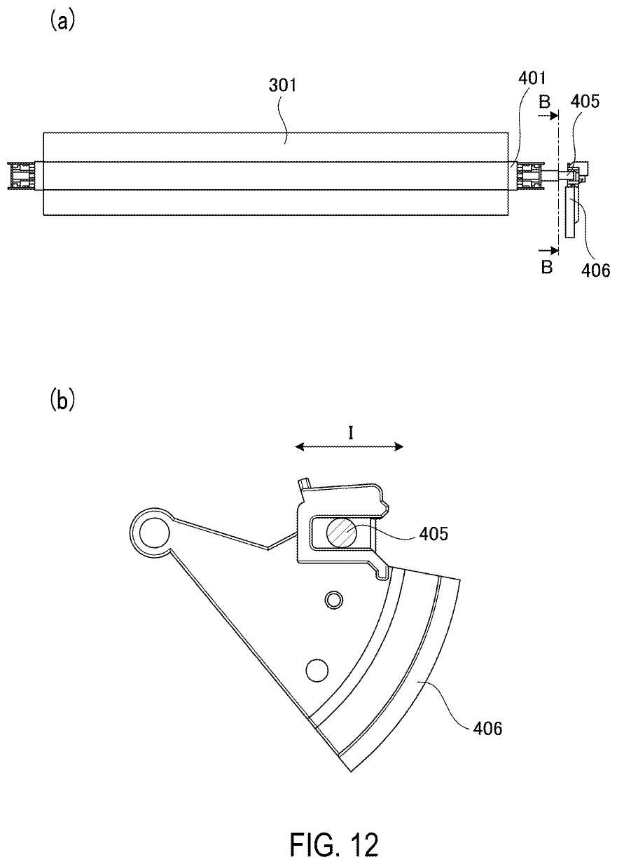

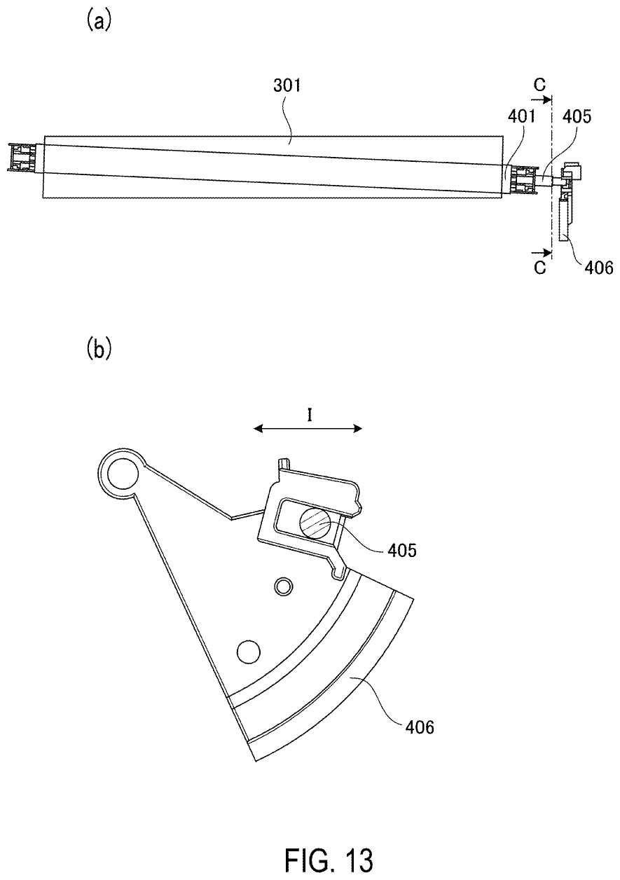

Next, an operation of the steering portion 403 during an opening operation of the door 101 of the image forming apparatus 1 will be described with reference to from FIG. 10 through part (b) of FIG. 13. FIG. 10 shows a flow of the operation. As shown in FIG. 10, when the control portion 30 detects that the door 101 has been opened from the signal of the opening/closing sensor 102 (S1), based on a detection signal of the detecting sensor 423 (S2), it controls the motor M2 which drives the steering arm 406 (S3 or S4).

That is, in S2, in a case that the signal from the detecting sensor 423 is ON (FIG. 7), the control portion 30 drives the motor M2 to move the steering arm 406 to a position where the steering roller 401 assumes the second angle (S3). In S2, in a case the signal from the detecting sensor 423 is OFF (FIG. 6), the control portion 30 drives the motor M2 to move the steering arm 406 to a position where the steering roller 401 assumes the first angle (S4). In this way, the control portion 30 determines the angle of the steering roller 401, when the door 101 is opened and, for example, the fixing device 8 is pulled out from the casing 100 of the image forming apparatus 1 for removing the recording material or performing maintenance on the fixing device 8.

As shown in part (a) of FIG. 11, in the embodiment, a state that the heating roller 307, the fixing pad 303, and the steering roller 401, which stretch over the fixing belt 301, are all parallel is a state that the steering roller 401 assumes the first angle. On the other hand, as shown in part (b) of FIG. 11, a state that the steering roller 401 is at a different angle from the heating roller 307 and the fixing pad 303 is a state that the steering roller 401 assumes the second angle.

As described above, in a case that the detection signal from the detecting sensor 423 when the door 101 is opened is ON, the recording material which is remained is in the nip portion N. In this case, it is assumed that the door 101 is opened in order to remove the recording material P from the nip portion N. Therefore, in the case that the detection signal from the detecting sensor 423 is ON during the opening operation of the door 101, the steering arm 406 is moved so that the steering roller 401 assumes a maximum steering angle (the second angle) in the B+direction which is shown in part (a) and part (b) of FIG. 4. In the embodiment, the maximum steering angle in the B+ direction is applied, however, the direction may be the B− direction, and the steering angle is not limited to the maximum steering angle.

In this way, by inclining the steering roller 401 so that the steering roller 401 is at the different angle from those of the heating roller 307 and the fixing pad 303, as shown in part (b) of FIG. 11, the fixing belt 301 is deformed from a cylindrical shape, and it is possible to significantly increase the resistance force when the force is applied in the direction which pulls the fixing belt 301 out in the width direction (Y direction).

For example, as shown in FIG. 8 which is described above, in a case that the recording material P is pulled in a direction (arrow G) which is inclined by approximately 60 degrees with respect to the conveyance direction (X direction) of the recording material in order to remove the recording material P from the nip portion N, when the heating roller 307, the fixing pad 303, and the steering roller 401 are all parallel to each other, the fixing belt 301 moves toward the front side of the fixing device 8 (arrow H direction) by approximately 20 mm due to a force which is generated during removing the recording material P. As a result, since the fixing belt 301 may move to the fully deviated position, it may cause an error to be detected when the fixing device 8 is returned to the image forming apparatus 1, or it may cause the fixing belt 301 to contact the other part and be damaged.

On the other hand, when the steering roller 401 is at the different angle from those of the heating roller 307 and the fixing pad 303, that is, the second angle, an amount of movement of the fixing belt 301, by the force which is generated during removing the recording material P, is decreased, and it is possible to limit the amount of movement to approximately 5 mm. Accordingly, it is possible to significantly reduce possibilities of the error detection and the damage to the fixing belt 301 which are described above.

In a case that the detection signal from the detecting sensor 423 is OFF when the door 101 is opened, since the recording material is not existed in the nip portion N, the removal of the recording material P from the nip portion N is not assumed to be a cause of the opening of the door 101. Actions which are performed on the fixing device 8 in this case are assumed to include the maintenance of the heating unit 300 inside the fixing device 8 and the part inside the heating unit 300 (the fixing belt 301), as described above. Further, it is also assumed that the recording material may be removed from the conveyance passage of the recording material other than that in the fixing device 8.

As described above, in the case that the detection signal from the detecting sensor 423 is OFF during the opening operation of the door 101, the steering arm 406 is moved and the steering roller 401 is at the neutral position (first angle). In the embodiment, the angle of the steering roller 401 at this time is set as the neutral position, however, it is not limited thereto, but the steering angle (the angle with respect to the predetermined direction) only needs to be smaller than the second angle.

As shown in part (a) and part (b) of FIG. 12, since a direction which inserts and removes the heating unit 300 from the fixing device 8 (I direction) is substantially parallel to the predetermined direction, it is possible to insert and remove without stress with respect to the steering arm 406 by setting the steering roller 401 to the neutral position. On the other hand, as shown in part (a) and part (b) of FIG. 13, in a state that the steering angle is applied to the steering roller 401, the steering shaft 405 is more likely to contact the other part such as the fixing belt 301 when the steering shaft 405 is inserted into or removed from the steering arm 406. Therefore, in the embodiment, in a case that the detection signal from the detecting sensor 423 is OFF during the opening operation of the door 101, the maintenance of the fixing device 8 becomes easier by setting the steering roller 401 to the neutral position.

Incidentally, when the door 101 is closed, the angle of the steering roller 401 is determined in accordance with a detected status by the optical sensors 412 of the lateral deviation position detecting portion 410A, regardless of whether the steering roller 401 is at the first angle or the second angle.

As described above, in the embodiment, it is possible to achieve both stability in removing the recording material which is remained in the nip portion N and replaceability of the respective parts which configures the fixing device 8 by changing the crossing angle of the fixing belt 301 with respect to the steering roller 401 when the door 101 is opened, depending on whether the recording material is remained in the nip portion N. That is, when the recording material is remained in the nip portion N during the opening operation of the door 101, the steering roller 401 is set to the second angle. Accordingly, it is possible to suppress the possibility of causing the positional deviation of the fixing belt 301 during the jam processing. Further, when the recording material is not remained in the nip portion N during the opening operation of the door 101, the steering roller 401 is set to the first angle. Accordingly, it is possible to improves the maintainability of the fixing device 8.

### Other Embodiments

In the embodiment which is described above, the configuration in which the halogen heater is provided as the heating portion which heats the fixing belt with the heating roller. However, the heating portion may be provided with another stretching member instead of providing the heating roller. Further, it may be provided with the pad member. For example, a plate shaped heating member such as a ceramic heater may be provided on a side of the fixing belt portion of the pad member. Further, the fixing belt may be heated by electromagnetic induction (IH). Further, in the embodiment which is described above, an external heating method may be applied where another heating member contacts and heats the belt or the roller from an external portion, instead of the heating portion which is disposed inside the roller,

Further, in the embodiment which is described above, the configuration which applies the pressing roller as the driving rotatable member is described. However, the driving rotatable member may be an endless belt which is stretched by a plurality of stretching rollers and driven by any one of the stretching rollers. Further, in the embodiment which is described above, the pressing roller as the driving rotatable member is pressed against the belt to form the nip portion, however, the belt may be configured to be pressed against the driving rotatable member. Furthermore, in the embodiment which is described above, the configuration which applies the fixing pad as a nip portion forming member is described, however, the nip portion forming member may also be a roller.

According to the present disclosure, it is possible to suppress the positional deviation of the belt member during the jam processing.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-082533 filed on May 16, 2025, which is hereby incorporated by reference herein in its entirety.

What is claimed is:

1. An image forming apparatus comprising:
a casing:
a fixing device disposed in the casing and configured to heat a toner image carried on a recording material and to fix the toner image onto the recording material;
a door provided to the casing so as to be openable and closeable, the door being configured to permit access to the fixing device in an opened state thereof; and
an opening/closing detecting portion configured to detect opening and closing of the door,
wherein the fixing device includes
an endless belt member,
a rotatable member configured to rotate in contact with an outer peripheral surface of the belt member and to form a nip portion for nipping and conveying the recording material between the rotatable member and the belt member,
a stretching roller disposed inside the belt member and configured to stretch the belt member,
a steering roller disposed so that a rotatable axis thereof is inclinable with respect to a predetermined direction parallel to a rotational axis direction of the stretching roller, the steering roller being configured to control a position of the belt member with respect to the rotational axis direction of the stretching roller by being inclined,
a driving portion configured to incline the steering roller, and
a recording material detecting portion configured to detect presence of the recording material in the nip portion,
wherein when the opening/closing detecting portion detects opening of the door in a state in which the recording material detecting portion does not detect the presence of the recording material, an angle of the steering roller to the predetermined direction becomes a first angle, and
wherein when the opening/closing detecting portion detects the opening of the door in a state in which the recording material detecting portion detects the presence of the recording material, the angle of the steering roller to the predetermined direction becomes a second angle larger than the first angle.

2. The image forming apparatus according to claim 1, wherein the first angle is an angle at which the rotational axis of the steering roller becomes substantially parallel to the predetermined direction.

3. The image forming apparatus according to claim 1, wherein the second angle is an angle of which the steering roller to the predetermined direction becomes maximum within a range in which the steering roller is capable of being inclined.

4. The image forming apparatus according to claim 1, further comprising a pad member disposed inside the belt member and configured to contact the belt member in the nip portion.

5. The image forming apparatus according to claim 1, wherein the stretching roller is a heating roller which includes a heating portion thereinside and heats the belt member by the stretching roller being heated by the heating portion.
